(19) United States
(12) Patent Application Publication
(10) Pub. No.: US 2025/0221572 A1
(43) Pub. Date: Jul. 10, 2025

(54) Modular Dual Action Herb Grinder with Customizable Inserts

(71) Applicants: Ken Campbell, Whiting, NJ (US); Zach Byers, Sylvania, OH (US)

(72) Inventors: Ken Campbell, Whiting, NJ (US); Zach Byers, Sylvania, OH (US)

(73) Assignee: Form & Void Studios, Whiting, NJ (US)

(21) Appl. No.: 18/405,724

(22) Filed: Jan. 5, 2024

(51) Int. Cl. A47J 42/14; A47J 42/20; A47J 42/40

(52) U.S. Cl. CPC A47J 42/14; A47J 42/20; A47J 42/40

(57) ABSTRACT

The present invention introduces an herb grinder integrating a unique dual action grinding mechanism within a modular cylindrical assembly, featuring customizable interlocking inserts.

The grinding chamber houses a distinct dual action grinding mechanism, enabling simultaneous grinding at two separate contact points. This is achieved with intermeshing concave teeth, optimized for wear resistance and efficient shearing. A secondary layer of convex teeth further refines the grind to pulverization. The grinding teeth are arranged in concentric rows on a foundational ring, interspersed with arcuate voids for both structural integrity and efficient manufacturing. Ground materials are channeled through a perforated matrix, leading to a storage chamber. Fine particulates sift through a screen insert and into a separate, enclosed chamber below.

Optimized for additive manufacturing, this herb grinder harnesses fused deposition modeling and stereolithography technologies, enabling precision at high speeds, and cost-effective production. This approach also facilitates enhanced aesthetic personalization, transcending the capabilities of traditional CNC manufacturing.

The customizable interlocking inserts not only offer aesthetic personalization but also serve as a platform for branding and dynamic QR code integrations for marketing engagement. The modular design of its enclosure ensures effortless use, cleaning, and thorough retrieval of ground material due to its easy disassembly.

This patent application serves to protect the underscored groundbreaking features and functionalities of the herb grinder contained therein, setting a new standard in grinding technology, operational efficiency, and user engagement.

REFERENCES CITED

| | | Publication |
|---|---|---|
| Patent Number: | Inventor(s): | Date: |
| #1: U.S. Pat. No. 4,280,666A | Robert H. Jones | 1981 Jul. 28 |
| #2: U.S. Pat. No. 6,945,486B2 | Eric Y. Teng | 2005 Sep. 20 |
| #3: U.S. Pat. No. 7,422,170B2 | Fan Bao | 2008 Sep. 09 |
| #4: U.S. Pat. No. 9,392,908B2 | Mark E. Edwards, | 2016 Jul. 19 |
| | Nathaniel I. Stewart | |
| #5: U.S. Pat. No. 10,039,418B2 | Mark Staiano, Dan | 2018 Aug. 07 |
| | Talbot | |
| #6: U.S. Pat. No. 10,694,894B1 | Jason Ashton | 2020 Jun. 30 |
| #7: US20220071448A1 | Matt Hansen, Mark | 2022 Mar. 10 |
| | Edwards | |
| #8: U.S. Pat. No. 11,779,057B2 | Artur Wozniak, | 2023 Oct. 10 |
| | Christopher Mennillo | |

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A LARGE TABLE, OR A COMPUTER PROGRAM LISTING APPENDIX ON READ-ONLY OPTICAL DISC

Not Applicable

### FIELD OF THE INVENTION

The present invention relates to grinding devices and pertains particularly to an apparatus for the efficient grinding of herbs which may also bear customizable interlocking inserts for marketing applications.

### BACKGROUND OF THE INVENTION

Traditional herb grinders typically comprise two-to-four piece enclosures with interlocking teeth on the grinding chamber's opposing surfaces. Manual rotation of the components grinds the contents which typically pass through apertures and into one or more chambers.

Historically, manufacturing these grinders was challenging due to their integral one-piece design, which often required intricate CNC machining. Limited to primarily metal, and more recently plastics, personalization methods like etching, anodization, patination, and electroplating are temporary and will often wear through with regular use within a few years or even months. These structures and manufacturing processes also restricted aesthetic customization as many were, and still are, produced with inseparable components. Similarly, without employing cost prohibitive techniques like injection molding, using plastics when seeking to emulate CNC manufacturing styles with fixed teeth are prone to breakage and rapid wear which compromises their grinding efficiency by attempting to replicate their function with a significantly less resilient manufacturing material. Despite their undeniable utility, these conventional designs often fall short in areas such as manufacturing efficiency, cost effectiveness, longevity, durability, cleaning ease, customization, and end user personalization.

What is needed is an herb grinder that overcomes the aforementioned limitations. Specifically, what is needed is an herb grinder designed for enhanced manufacturing efficiency and cost effectiveness, which allows for robust construction without the high costs and associated complexities of intricate CNC machining or injection molding while retaining comparable durability. Additionally, an herb grinder that can be made from a variety of materials without compromising longevity and durability is desirable. An ideal design would contain a modular assembly to facilitate easy cleaning and a purposefully designed intermeshing grinding mechanism whose complex albeit simple function extends its usable life. Furthermore, a quintessential herb grinder would offer a high degree of long-lasting aesthetic customization, enabling users to personalize their grinders to reflect their individual tastes and preferences. Such a grinder should also address the shortcomings of traditional plastic designs, providing the efficiency and strength of CNC-machined designs without the associated fragility or rapid wear. Ultimately, what is needed is a next-generation herb grinder that combines next-level functionality, significant durability, and whole unit personalization, all while addressing the inherent issues associated with conventional designs.

### DESCRIPTION OF THE PRIOR ART

The present invention seeks to provide solutions to shortcomings, both functional and aesthetic, presented in previously established designs while expanding the utility of the present invention to include a focus on personalization and marketing applications.
Patent Reference #1: U.S. Pat. No. 4,280,666A
[Robert H. Jones—1981 Jul. 28]
One significant patent that stands out in the evolutionary trajectory of herb grinders is U.S. Pat. No. 4,280,666A. This patent represents an earlier generation of grinders and serves as an illustrative benchmark against which we can measure the advancements made by the present invention. The described function of U.S. Pat. No. 4,280,666A set a long-reaching standard for hand-operated herb grinding devices that retains its significance even today.
This prior art consists of multiple components with interlocking teeth engineered for the grinding of organic materials such as condiments, with a predominant focus on enhancing the effectiveness of handheld grinding devices which operate by counter-rotating or otherwise manipulating a pair of hand rotors through a twisting motion.
While the present invention also implements the use of a hand rotor, the present invention introduces an innovative dual action grinding mechanism which allows for grinding of material at two separate points of contact within the grinding chamber simultaneously in a way that cannot be replicated by U.S. Pat. No. 4,280,666A's single action approach to herb grinding.
The present invention is optimized for additive manufacturing processes such as fused deposition modeling and stereolithography. This manufacturing focus not only allows for intricate design features to be achieved rapidly and inexpensively, but also surpasses the manufacturing techniques available at the time in which U.S. Pat. No. 4,280,666A was published.
While U.S. Pat. No. 4,280,666A suggests interlocking components, the present invention takes this a step further by offering a modular assembly to house its dual action grinding mechanism while also bearing customizable interlocking inserts. These inserts enhance personalization options while enabling unique branding opportunities. Furthermore, dynamic QR codes can be implemented, allowing marketers to engage with end users. Similar to the aforementioned manufacturing capabilities, the technology for these personalization features would not have been available, nor possible at the time of U.S. Pat. No. 4,280,666A's publication.
The present invention also has the ability to be disassembled to a degree far greater and more thorough than the design shown in U.S. Pat. No. 4,280,666A. The modularity of the present invention's assembly enhances user-friendliness, simplifies cleaning, and ensures better retention of ground material. In contrast, U.S. Pat. No. 4,280,666A does not emphasize any modular aspects in its design, nor does it mention any associated benefits of such construction considerations.
U.S. Pat. No. 4,280,666A established a foundation for the core concepts of hand-held grinders and served as a relevant precedent in the field of grinding devices. While the present invention introduces new unique features and improvements largely made possible by current technologies, acknowledging this important historical patent underscores the definitive advancement of technology in this domain overall.
In conclusion, while U.S. Pat. No. 4,280,666A represents a fundamental first step in the lineage of herb grinder development, the present invention embodies the next evolutionary stage. It harnesses modern manufacturing techniques, offers enhanced user personalization and branding capabilities, while also introducing advanced grinding mechanics which rival their metallic CNC machine created relatives. In the spectrum of herb grinder design, the present invention stands as a testament to innovation built upon the historical foundations laid by U.S. Pat. No. 4,280,666A.
Patent Reference #2: U.S. Pat. No. 6,945,486B2
[Eric Y. Teng—2005 Sep. 20]
Building on the principle of functional complexity in handheld herb grinding tools, U.S. Pat. No. 6,945,486B2 proposes a garlic processing tool which emphasizes simplicity and efficiency while providing more complexity in function. Instead of a grinding rotor, it features two disc-shaped presser units with opposite-facing rotary grating means, which allows for the peeling, pressing, and grating of garlic cloves. This progression signifies a shift from a single action grinding approach to a multi-faceted processing technique.
As a novel continuation, the present invention integrates the foundational ideas of complex herb processing, introducing a more comprehensive approach. U.S. Pat. No. 6,945,486B2 provided solutions to challenges such as the need for pre-peeling, wastage, and cleaning difficulties associated with traditional garlic presses. Comparatively, the present invention employs a dual action grinding mechanism which facilitates the grinding and eventual pulverization of herbs in a way that separates ground material from particulate leavings (also referred to as “trichomes”) in a particular fashion.
The interactions which occur at the various engagement surfaces between corresponding sets of primary and secondary teeth rings within the present invention's grinding chamber create an environment which functions more similarly to a tumbler than a thresher despite the sharp edges featured within either. This process allows the trichomes to be shaken off and safely sieved to their named chamber which resides at the lowest point before the larger leavings are made fine enough to descend to the collection chamber existing between the grinding chamber and the aforementioned trichome chamber.
This extrapolation of U.S. Pat. No. 6,945,486B2's disclosed two-piece enclosure to an expanded assembly which broadens the present invention's profile to include a storage area separate from the grinding chamber. This storage chamber contains a screen insert and is attached to a trichome chamber to collect particulate leavings.
U.S. Pat. No. 6,945,486B2, like the present invention, suggests the implementation of polycarbonates as a manufacturing material in one embodiment while also suggesting the use of alternatives in other embodiments. This shares many similarities with the present invention. However, unlike U.S. Pat. No. 6,945,486B2, the present invention leverages its optimization for additive manufacturing to allow a unique approach to personalization and advertising opportunities through its inclusion of optional branding and QR code inserts.
The considerations brought forth by the present invention are thoughtful expressions of expansion on the conceptual similarities between it and designs like those outlined in U.S. Pat. No. 6,945,486B2. They showcase features which demonstrate an understanding of the same foundational principles upon which U.S. Pat. No. 6,945,486B2 are built while advancing what is possible by suggesting new answers to tired problems, solutions for contemporary user needs, and opportunities to affect market dynamics in other industries.
Patent Reference #3: U.S. Pat. No. 7,422,170B2
[Fan Bao—2008 Sep. 9]
The primary innovation introduced by U.S. Pat. No. 7,422,170B2 was the detachable grinding plate system, engineered to circumvent manufacturing costs and enhance aesthetic versatility. As with previous designs, when the actuator is turned, the teeth rotate to provide the grinding action at a single point of contact between individual teeth. The plates upon which these teeth sit are connected via magnetic elements, signifying a shift from traditional manufacturing techniques and attachment mechanisms. While U.S. Pat. No. 7,422,170B2 seeks to ease the burden of manufacturing while improving options for aesthetic personalization, the present invention ultimately offers a greater scope in both areas.
This is realized by not requiring the bonding of multiple types of materials to accomplish a comparable detachable functionality evidenced by the construction of U.S. Pat. No. 7,422,170B2's grinding chamber. Similarly, the present invention is not subject to the limitations in the methods by which colors and textures are applied to alternative manufacturing materials like anodization, patination, or electroplating. While each of the aforementioned color application processes have their respective pros and cons, they are aligned by the fact that the present invention's additive manufacturing optimization would see any color applications through to their literal core instead of merely applying a coating regardless of the specific application method.
The present invention's implementation of a modular assembly not only enhances its functionality but also opens new avenues for marketing applications by means of offering optional branding and dynamic QR code inserts, catering to a market-centric approach. While established functional benefits of additive manufacturing are apparent, the aesthetic options for colors, textures, and special finishes are diversified exponentially as well. Additionally, whereas U.S. Pat. No. 7,422,170B2 uses interior magnetized ridges and surfaces to fully assemble the unit, the present invention's modular enclosure is designed to snap together for quick and simple disassembly which does not require an intermediary bonding element like magnetization or adhesives to maintain purposeful attachment of moving parts when in use.
The present invention also implements an innovative dual action grinding mechanism characterized by sets of primary concave teeth which engage slidably in a shearing motion and sets of secondary convex teeth to further refine the grind by pulverizing ground material before passing through a plurality of apertures and into a storage chamber. Conversely, the design presented in U.S. Pat. No. 7,422,170B2 incorporates what is conclusively a single action grinding mechanism regardless of the implementation of its layered plate system and its arrangement of cutting elements within the provided grinding plates.
The present invention embodies a distinct progression, drawing inspiration from while also expanding upon the foundational principles of earlier grinder designs like those exemplified in U.S. Pat. No. 7,422,170B2, integrating modern technological advancements in both manufacturing and digital marketing to the ultimate benefit of potentially establishing a new state of the art.
Patent Reference #4: U.S. Pat. No. 9,392,908B2
[Mark E. Edwards, Nathaniel I. Stewart—2016 Jul. 19]
A modern standard, U.S. Pat. No. 9,392,908B2 discloses a cylindrical herb grinder optimized for dried materials. Comprising a top and base element, it features concentrically arranged, serrated teeth that engage in a slicing motion during counter-rotation to grind contents. Ground contents pass through a field of apertures and descend into an open chamber lined with a mesh screen. Particulate matter descends beyond and through the mesh screen and into a lower closed chamber.
Due to the implementation of milling and lathe processes, including their related materials, designs like those referenced in U.S. Pat. No. 9,392,908B2 necessitate marrying certain components which become physically inseparable as a result. While fusing select components together can improve overall stability of the unit, the ramifications of this style of manufacturing become apparent over time and through wear and tear. Combining elements in this fashion can often make cleaning difficult and discourages the retention of finer ground material which may become trapped in grooves or crevices that are inaccessible and cannot be further engaged due to the physical impossibility of disassembly.
Furthermore, should married components become disconnected, many potential negative outcomes are possible: Formerly bonded parts cannot be permanently reattached and attempting to use damaged components within existing embodiments can result in reduced functional capacity, outright mechanical failure, or even possible contamination of contents due to new points of friction which should not exist. Conversely, the present invention's utilization of additive manufacturing, modular design, and interlocking inserts removes the potential for these unfortunate likelihoods.
Beyond the functional benefits of optimizing for fused deposition modeling and stereolithography into the manufacturing process, they allow for a level of customization not possible with CNC manufacturing techniques. Moreover, these approaches allow for a greater diversity of aesthetic preferences including but not limited to combined colors, textures, and treatments that cannot be replicated by existing CNC customization methods.
U.S. Pat. No. 9,392,908B2's design boasts a sophisticated array of cleverly serrated teeth which slidably engage with one another to achieve their grind. This single action grinding mechanism is highly praiseworthy due to the efficiency of its design, however, the dual action grinding mechanism introduced by the present invention integrates a revolutionary intermeshing teeth design wherein corresponding sets of concave and convex teeth pass through one another while progressively grinding trapped contents further as they concurrently engage with a second point of contact which pulverizes ground material after trichomes have been shaken free. As previously mentioned, the way in which ground material moves throughout the grinding chamber during actuation of the present invention's dual action grinding mechanism functions mechanically separately from the function of the teeth designed for U.S. Pat. No. 9,392,908B2's grinding chamber.
While both inventions focus on improving herb grinding technology, the function of the present invention's innovative grinding mechanism, its modular assembly, additive manufacturing optimization, and emphasis on personalization for marketing integration set it distinctly apart from the prior art of U.S. Pat. No. 9,392,908B2.
Patent Reference #5: U.S. Pat. No. 10,039,418B2
[Mark Staiano, Dan Talbot—2018 Aug. 7]
U.S. Pat. No. 10,039,418B2 introduces an herb grinder system tailored for grinding herbs, tobacco, and botanicals through interchangeable grinding and sifting plates. This system leverages these interchangeable grinding plates baring multiple different blade configurations as well as a collection of sifting plates containing varying hole sizes with the intended purpose of enabling users to have more control over their experience. This is achieved by allowing users to customize the coarseness of grind with a preferred combination of the aforementioned plates. This design sees the incorporation of threading and bayonet mounts for securing its components and aiding use of its various plates' interchangeability.
While both U.S. Pat. No. 10,039,418B2 and the present invention emphasize a modular assembly, the latter aims to provide a more intuitive experience while innovating in the areas of functionality and personalization. This is achieved by simplifying the overall design and reducing the total number of parts, thereby streamlining assembly, and eliminating potential user confusion. Unlike the bayonet mounts in U.S. Pat. No. 10,039,418B2—which counteract material wear from friction—the present invention enlists a unique approach to design which considers existing engagement points and joins them via a press-fitting attachment system and retention ring to lock the components in place and prevents unintended movement. This ensures that grinding elements remain secure without the need of an additional adhesive, eliminating unintentional disassembly and any concerns about the mechanism loosening over time.
In terms of grinding capabilities, U.S. Pat. No. 10,039,418B2 offers a simple system with distinct upper and lower grinding plates with traditionally designed, albeit creatively arranged teeth. In contrast, the present invention incorporates both rectilinear and curvilinear elements, working in harmony to deliver a superior grind through its dual action grinding mechanism. Although the system described in U.S. Pat. No. 10,039,418B2 provides several plate configurations for different outcomes, none of these configurations can replicate the unique grinding mechanism introduced by the present invention.
The present invention is optimized to adopt modern additive manufacturing techniques, offering enhanced options for aesthetics and personalization, whereas U.S. Pat. No. 10,039,418B2 focuses strictly on functional improvements like interchangeable plates and screens. It does not suggest any manufacturing techniques for any purposes, although it may be inferred that milling and lathing processes would likely be key to its manufacturing due to the design of its components.
While U.S. Pat. No. 10,039,418B2 emphasizes functional improvements, the present invention presents several of its own while also adopting advanced additive manufacturing techniques, fostering both functional and aesthetic enhancements. This modern approach, combined with the inclusion of customizable interlocking branding and QR code inserts for marketing applications, differentiates the present invention from previous designs such as
U.S. Pat. No. 10,039,418B2.
Patent Reference #6: U.S. Pat. No. 10,694,894B1
[Jason Ashton—2020 Jun. 30]
U.S. Pat. No. 10,694,894B1 presents an herb processor with two corresponding grinding elements, upper and lower, featuring blades that extend in specific patterns and regions devoid of blades for a crush-free zone. These blades, shaped as flattened, truncated pyramids, engage with each other without interference, ensuring material is finely processed.
Comparatively, the present invention utilizes a unique grinding mechanism enlisting the use of primary concave teeth for initial shearing and secondary convex teeth for additional pulverization which intermesh with one another. While U.S. Pat. No. 10,694,894B1's grinding mechanism also contains intermeshing teeth, the grinding mechanism functions with a single action. Further, it may be inferred that the viability of the disclosed teeth design would be dubious if replicated with the same additive manufacturing techniques for which the present invention is optimized.
The present invention features a more intricate grinding mechanism and is also designed with stability as paramount. Due to the construction of the teeth ring base, how said teeth rings are set within said base, the specificity of blade geometry, and the arcuate spaces which connect them, the present invention's grinding mechanism offers increased complexity in function, ease of use, stability over time, and protection of engagement surfaces from wear. Additionally, the present invention introduces a unique network of intermeshing rectilinear and curvilinear grinding elements which allow for grinding at two points of contact simultaneously, compared to the single action grinding mechanism disclosed in U.S. Pat. No. 10,694,894B1.
Furthermore, the present invention introduces customizable interlocking inserts to enhance personalization and marketing capabilities, making it distinct in its adaptability and branding potential from designs like U.S. Pat. No. 10,694,894B1. Due to the forms composing U.S. Pat. No. 10,694,894B1's grinding mechanism not being optimized for additive manufacturing techniques; the same aesthetic limitations apply.
While both inventions aim to improve herb grinding technology, the present invention's focus on a dual action grinding mechanism, additive manufacturing optimization, customizability, and branding utilization sets it apart from both the design and functionality of U.S. Pat. No. 10,694,894B1.
Patent Reference #7: US20220071448A1
[Matt Hansen, Mark Edwards—2022 Mar. 10]
A spiritual successor to U.S. Pat. No. 9,392,908B2 (Patent Reference #4), US20220071448A1 discloses an herb grinder design consisting of four primary components: an upper and lower grinding rotor—both fitted with meshing teeth, a sifter, and a bottom chamber. As material is ground, it transitions through a series of holes in the lower grinding plate and into a screen which filters finer particles into a final collection area at the bottom of the unit. The sifter design included in US20220071448A1 is notable in that it differs from traditional wire mesh constructions by employing a planar sifting plate which allows for the application of either plastic or metal building materials.
Contrasting earlier iterations in herb grinder designs like those featured in US20220071448A1, the present invention integrates a dual action grinding mechanism. This proprietary mechanism allows simultaneous grinding at two distinct contact points using a combination of concave and convex teeth, a departure from US20220071448A1's traditional approach to meshing teeth.
Additionally, while US20220071448A1's sifting plate was novel, it offers no distinct or obvious benefits over the included screen which resides in the present invention's collection chamber. The present invention's screen insert adopts a minimalist approach which favors additive manufacturing and seeks to maximize manufacturing efficiency by creating an effective sifter that works identically to the familiar mesh screen included in designs like US20220071448A1, but which can be produced as simply and inexpensively as the rest of the components in the assembly. Moreover, the process by which the screen insert featured in the present invention is made reduces production times by not requiring separate machining or aftermarket parts to perform a basic, albeit necessary function.
The manufacturing methodologies between US20220071448A1 and the present invention also diverge significantly. The design brought forward by US20220071448A1 can be constructed using biodegradable materials like hemp and is fashioned using a type of laser or pressurized water etching via CNC manufacturing techniques. In stark contrast, the present invention can also be manufactured out of these same materials while also harnessing modern additive manufacturing, tapping into fused deposition modeling and stereolithography, thereby enhancing precision, cost savings, and aesthetic customization beyond the scope outlined in US20220071448A1. Furthermore, the present invention's modular design stands out, ensuring user-friendly operation, simplified cleaning, and efficient material retrieval. This is complemented by its ability to offer advanced aesthetic personalization, branding capabilities, and QR code integrations, serving marketing engagements.
In summation, while both grinders aim to advance the efficiency of herb grinding, the present invention sets a novel standard in grinding technology via its unique dual action grinding mechanism, modular assembly, modern manufacturing approach, and focus on user engagement, expanding beyond the foundational features of US20220071448A1.
Patent Reference #8: U.S. Pat. No. 11,779,057B2
[Artur Wozniak, Christopher Mennillo—2023 Oct. 10]
The herb grinder disclosed in U.S. Pat. No. 11,779,057B2 comprises a receptacle grinding member and an insertable grinding element. These components have respective grinding surfaces that define a multitude of elongated grooves, forming contiguous protruding structures. When the insertable element rotates within the receptacle grinding member, the herbs are ground between the interfacing grinding surfaces. These grinding surfaces contain openings which allow ground herbs to pass into the tubular housing structure. It also includes features like an enclosure plate, magnets in the grinding surfaces, and specific configurations of elongated grooves which make up an ostensibly toothless grinding mechanism.
Manufacturing techniques are not suggested by U.S. Pat. No. 11,779,057B2. This may be a condition of the many solutions offered by this design which are not exclusive to any specific manufacturing process. However, an undisclosed benefit of U.S. Pat. No. 11,779,057B2's grinding mechanism design is that it circumvents a common issue present in herb grinder designs which seek to replicate designs typically achieved with CNC-manufacturing, but which use additive manufacturing to achieve them. Generally, attempting to replicate these teeth styles with additive manufacturing techniques like fused deposition modeling results in a short lifespan for the grinding mechanism. U.S. Pat. No. 11,779,057B2 creates a solution to this problem by creating an evidently toothless design that is not subject to the same breakage and wear issues as traditional teeth designs. The present invention utilizes a combination of intricate engineering and unique blade geometry to achieve alternative solutions to the potential issues defined by U.S. Pat. No. 11,779,057B2; Especially as they apply to herb grinders produced by means of additive manufacturing. Similarly, while U.S. Pat. No. 11,779,057B2 engages unique grinding elements, its function is separate from the present invention's use of a dual action grinding mechanism.
Moreover, while U.S. Pat. No. 11,779,057B2 delivers a novel grinding experience, no considerations for customization or personalization are present. Conversely, the present invention creates a similarly exceptional improvement in the field of grinding technology while also creating opportunities for branding and marketing applications.
Considering that both patents strive to innovate herb grinding technology, the present invention differs significantly in design and grinding mechanism function from U.S. Pat. No. 11,779,057B2. They also take separate paths towards solutions to the same problems. However, the present invention's means of achieving them offer users a more familiar albeit innovative approach as well as the freedom to personalize to a degree not offered by U.S. Pat. No. 11,779,057B2.

### BRIEF SUMMARY OF THE INVENTION

The present invention discloses a novel herb grinder characterized by a modular cylindrical assembly and a unique dual action grinding mechanism. This mechanism, embedded within the grinding chamber, facilitates simultaneous grinding at two distinct contact points using intermeshing concave teeth. These teeth, renowned for their wear resistance and shearing efficiency, are organized in concentric rows with strategic arcuate voids, ensuring both structural robustness and manufacturing efficacy. A supplementary layer of convex teeth elevates the grinding process, directing ground materials back into the slope of the nearest primary teeth to pulverize said materials which are then sieved through a perforated matrix to a primary storage chamber. Additionally, finer particles are sieved through a specialized screen insert, segregating them in an isolated chamber.

A salient feature of this grinder is its alignment with additive manufacturing techniques, notably fused deposition modeling and stereolithography. These advanced technologies empower the invention with unmatched precision, cost-efficiency, and a distinct aesthetic edge over conventional CNC-manufactured grinders.

Further enhancing its appeal is the integration of customizable interlocking inserts. These not only pave the way for aesthetic personalization but also function as a canvas for branding endeavors, specifically through dynamic QR code inclusions. User experience remains paramount with the present invention's modular framework, simplifying tasks like usage, cleaning, and material retrieval through its effortless disassembly feature.

In another embodiment, the top and bottom most components of the assembly can be made flat for users that want to take advantage of the proprietary grinding technology offered by the present invention, but which may not have need for branding inserts, or may want to decorate their herb grinder personally.

Through this invention, we aim to redefine standards in herb grinding technology, championing innovation in design, operational efficiency, and heightened user engagement.

### OBJECTIVE OF THE INVENTION

The primary objective of the present invention is to revolutionize the design and functionality of herb grinders by incorporating a distinctive dual action grinding mechanism that facilitates simultaneous grinding at two separate contact points between corresponding curvilinear and rectilinear grinding elements. This innovative mechanism is designed to make functional improvements in grinding efficiency, consistency of ground material, and protection of grinding surfaces from direct contact thereby increasing their long-term durability and keeping shearing edges from dulling.

A secondary objective is to introduce a modular cylindrical design that emphasizes ease of use to facilitate cleaning and the comprehensive extraction of ground material. Another key objective is to harness additive manufacturing techniques such as fused deposition modeling and stereolithography, thereby achieving highly precise, swift, and cost-effective production, which also surpasses the limitations of conventional CNC manufacturing.

Furthermore, the present invention aims to present a transformative approach to personalization, branding, and aesthetic enhancements in the realm of herb grinders. This is achieved through the integration of customizable interlocking branding inserts, which can function as a marketing tool and further include dynamic QR code integrations to facilitate user engagement.

The overarching goal of the present invention is to set a new standard for herb grinders by merging unparalleled functionality with advanced manufacturing methods and versatile personalization capabilities. Through these objectives, the present invention intends to set new benchmarks in grinding technology, efficiency, and user centric design.

### BRIEF DESCRIPTION OF THE SEVERAL VIEWS OF DRAWINGS

FIG. 1A—is an isometric top view of an herb grinder assembly according to an embodiment of the present invention, with dashed lines illustrating sample artwork and serving as a visual guide for customization.

FIG. 1B—is an isometric view of the bottom of an herb grinder assembly according to an embodiment of the present invention, with dashed lines illustrating sample artwork and serving as a visual guide for customization.

FIG. 1C—is an exploded perspective view of a disassembled herb grinder assembly according to an embodiment of the present invention, with dashed lines illustrating sample artwork and serving as a visual guide for customization.

FIG. 2A—is a perspective top view of a branding frame insert according to an embodiment of the present invention, with dashed lines illustrating sample artwork and serving as a visual guide for customization.

FIG. 2B—is a perspective view of the bottom of a branding frame insert according to an embodiment of the present invention, with dashed lines illustrating sample artwork and serving as a visual guide for customization.

FIG. 2C—is an orthographic view of the bottom of a branding frame insert according to an embodiment of the present invention, with dashed lines illustrating sample artwork and serving as a visual guide for customization.

FIG. 2D—is a sectional profile view of a branding frame insert representing Section A-A, according to an embodiment of the present invention.

FIG. 3A—is a perspective top view of a branding plate insert according to an embodiment of the present invention, with dashed lines illustrating sample artwork and serving as a visual guide for customization.

FIG. 3B—is an orthographic top view of a branding plate insert according to an embodiment of the present invention, with dashed lines illustrating sample artwork and serving as a visual guide for customization.

FIG. 3C—is a sectional profile view of a branding plate insert representing Section B-B according to an embodiment of the present invention.

FIG. 4A—is a perspective top view of an optional combined branding insert assembly according to an embodiment of the present invention.

FIG. 4B—is a perspective top view of a combined branding insert according to an embodiment of the present invention.

FIG. 4C—is an orthographic top view of a combined branding insert according to an embodiment of the present invention.

FIG. 4D—is a sectional profile view of a combined branding insert representing Section C-C according to an embodiment of the present invention.

FIG. 5A—is a perspective top view of an upper grinding element according to an embodiment of the present invention, wherein dashed lines indicate an optional slot for a combined branding insert in another embodiment.

FIG. 5B—is a perspective top view of the underside of an upper grinding element according to an embodiment of the present invention.

FIG. 5C—is an orthographic top view of the underside of an upper grinding element according to an embodiment of the present invention.

FIG. 5D—is a sectional profile view of an upper grinding element representing Section D-D according to an embodiment of the present invention.

FIG. 6A—is a perspective top view of a branded upper grinding element assembly according to an embodiment of the present invention.

FIG. 6B—is a perspective top view of a branded upper grinding element according to an embodiment of the present invention.

FIG. 6C—is an orthographic top view of a branded upper grinding element according to an embodiment of the present invention.

FIG. 6D—is a sectional profile view of a branded upper grinding element representing Section E-E according to an embodiment of the present invention.

FIG. 7A—is a perspective top view of a lower grinding element according to an embodiment of the present invention.

FIG. 7B—is an orthographic top view of a lower grinding element according to an embodiment of the present invention.

FIG. 7C—is a sectional profile view of a lower grinding element representing Section F-F according to an embodiment of the present invention.

FIG. 8A—is a perspective top view of a grinding chamber shell according to an embodiment of the present invention.

FIG. 8B—is an orthographic top view of a grinding chamber shell according to an embodiment of the present invention.

FIG. 8C—is a sectional profile view of a grinding chamber shell representing Section G-G according to an embodiment of the present invention.

FIG. 9A—is a perspective top view of a grinding chamber base assembly according to an embodiment of the present invention.

FIG. 9B—is a perspective top view of a grinding chamber base according to an embodiment of the present invention.

FIG. 9C—is an orthographic top view of a grinding chamber base according to an embodiment of the present invention.

FIG. 9D—is a sectional profile view of a grinding chamber base representing Section H-H according to an embodiment of the present invention.

FIG. 10A—is a perspective top view of a dual action grinding mechanism assembly according to an embodiment of the present invention.

FIG. 10B—is a perspective sectional profile view revealing a detailed look at a dual action grinding mechanism illustrating engagement surfaces of intermeshing teeth and the interaction points between corresponding sets of primary and secondary teeth according to an embodiment of the present invention.

FIG. 10C—is a composite sectional profile view composed by overlaying views Section D-D and Section F-F, revealing a dual action grinding mechanism illustrating engagement surfaces of its intermeshing teeth and the interaction points between corresponding sets of primary and secondary teeth, including detail windows with close-up views according to an embodiment of the present invention.

FIG. 11A—is a perspective top view of a screen insert according to an embodiment of the present invention.

FIG. 11B—is an orthographic top view of a screen insert with an enlarged detail window illustrating a close-up view according to an embodiment of the present invention.

FIG. 11C—is a sectional profile view of a screen insert with an enlarged detail window illustrating a close-up view representing Section I-I according to an embodiment of the present invention.

FIG. 12A—is a perspective top view of a storage chamber shell according to an embodiment of the present invention.

FIG. 12B—is an orthographic top view of a storage chamber shell according to an embodiment of the present invention.

FIG. 12C—is a sectional profile view of a storage chamber shell representing Section J-J according to an embodiment of the present invention.

FIG. 13A—is a perspective top view of a storage chamber base assembly according to an embodiment of the present invention.

FIG. 13B—is perspective top view of a storage chamber base according to an embodiment of the present invention.

FIG. 13C—is an orthographic top view of a storage chamber base with an enlarged detail window illustrating a close-up view according to an embodiment of the present invention.

FIG. 13D—is a sectional profile view of a storage chamber base representing Section K-K with an enlarged detail window illustrating a close-up view according to an embodiment of the present invention.

FIG. 14A—is a perspective top view of a trichome chamber according to an embodiment of the present invention.

FIG. 14B—is a perspective top view of the underside of a trichome with dashed lines indicating an optional QR code insert chamber according to an embodiment of the present invention.

FIG. 14C—is an orthographic top view of a trichome chamber according to an embodiment of the present invention.

FIG. 14D—is a sectional profile view of a trichome chamber representing Section L-L according to an embodiment of the present invention.

FIG. 15A—is a perspective top view of an optional QR code insert with dashed lines illustrating sample artwork and serving as a visual guide for customization, according to an embodiment of the present invention.

FIG. 15B—is an orthographic top view of an optional QR code insert with dashed lines illustrating sample artwork and serving as a visual guide for customization, according to an embodiment of the present invention.

FIG. 15C—is a sectional profile view of an optional QR code insert representing Section M-M according to an embodiment of the present invention.

FIG. 16A—is a perspective top view of a branded trichome chamber assembly according to an embodiment of the present invention.

FIG. 16B—is a perspective top view of the underside of a branded trichome chamber according to an embodiment of the present invention.

FIG. 16C—is an orthographic top view of the underside of a branded trichome chamber with dashed lines illustrating sample artwork and serving as a visual guide for customization according to an embodiment of the present invention.

FIG. 16D—is a sectional profile view of a branded trichome chamber representing Section N-N according to an embodiment of the present invention.

### DETAILED DESCRIPTION OF THE INVENTION

The inventors provide a novel herb grinder enabling user customization, associated benefits of a modular assembly, a dual action grinding mechanism, and digital marketing applications via customizable interlocking branding inserts. The present invention is described in enabling detail in the following examples, which may represent more than one embodiment of the present invention. In this description, the inclusion of positional terms like “top”, “bottom”, “upper”, “lower”, and etc. serve only to orient the components of the present invention and their respective elements in the figures and are not meant to restrict other embodiments.

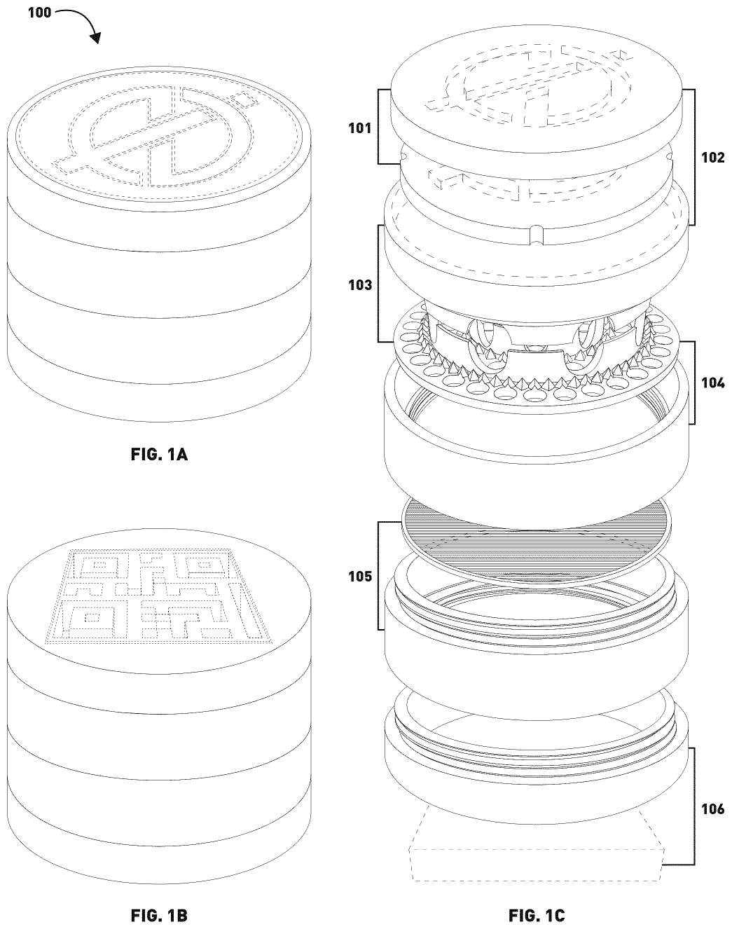

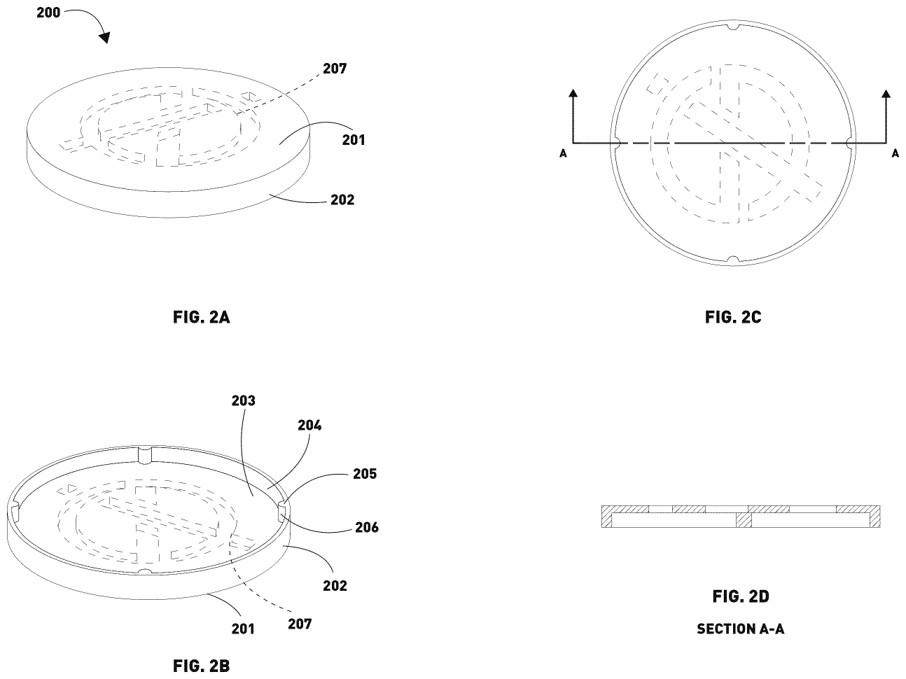

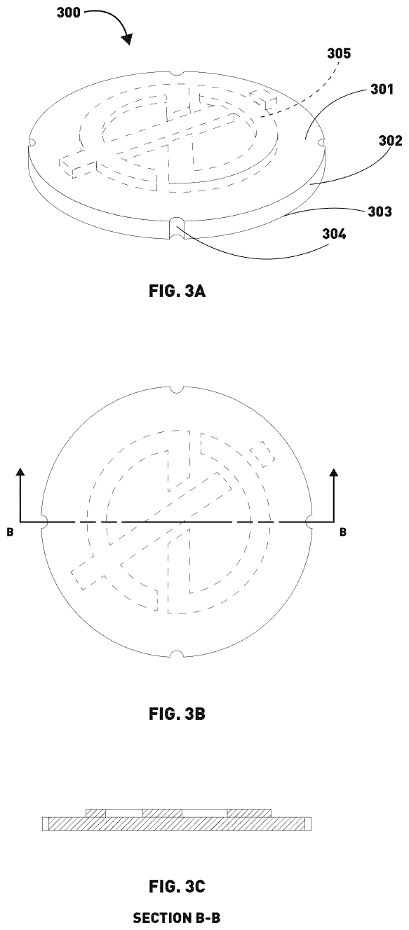

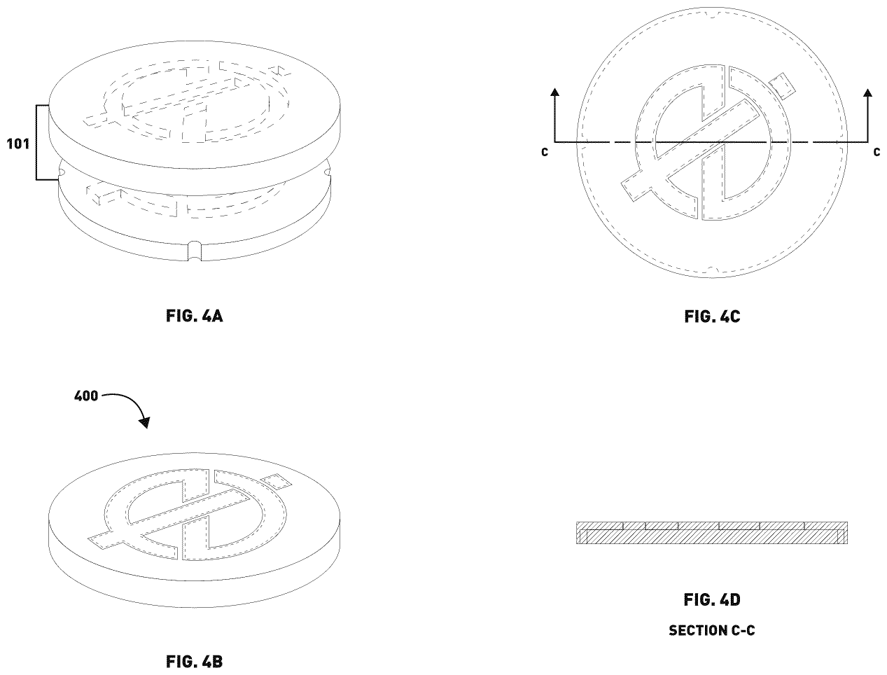

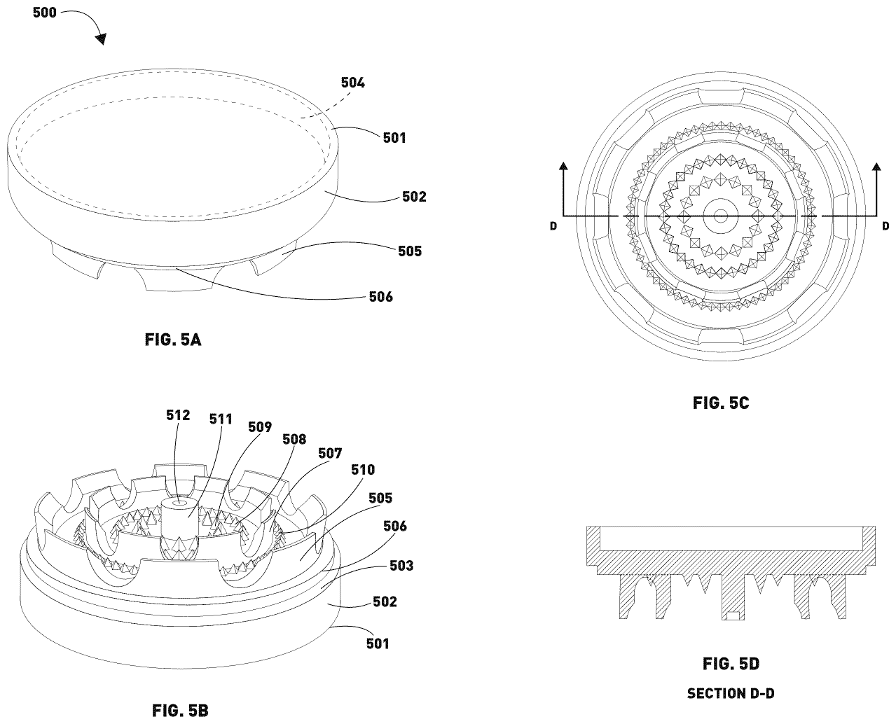

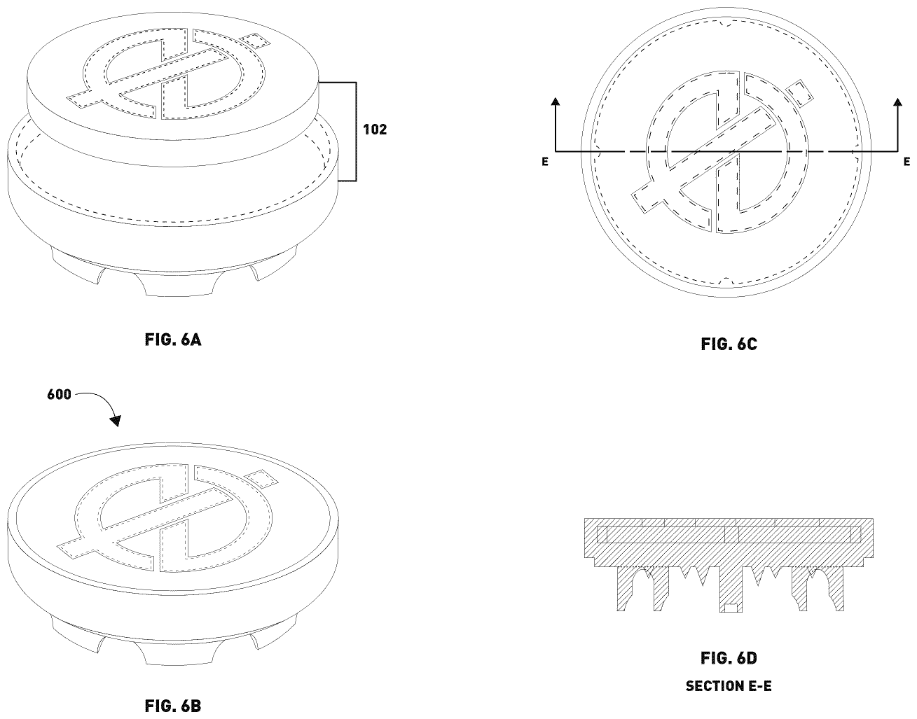

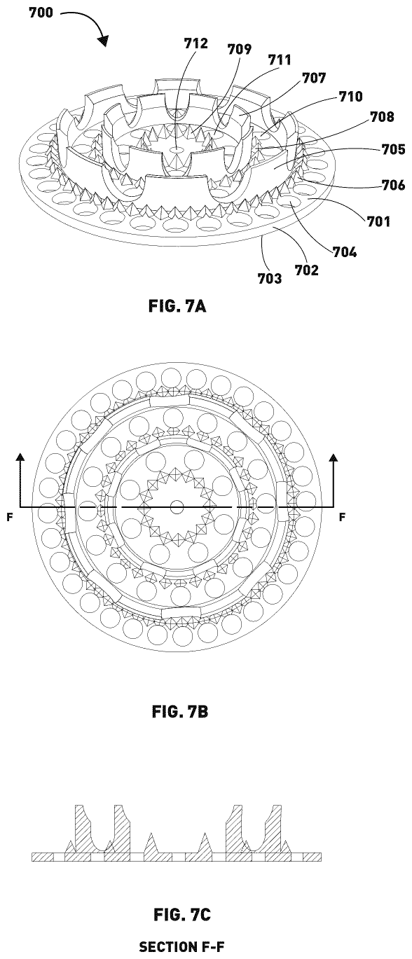

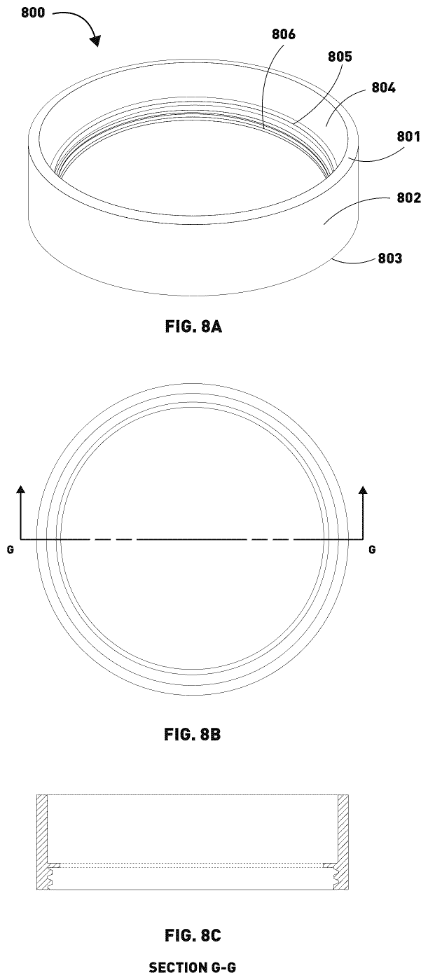

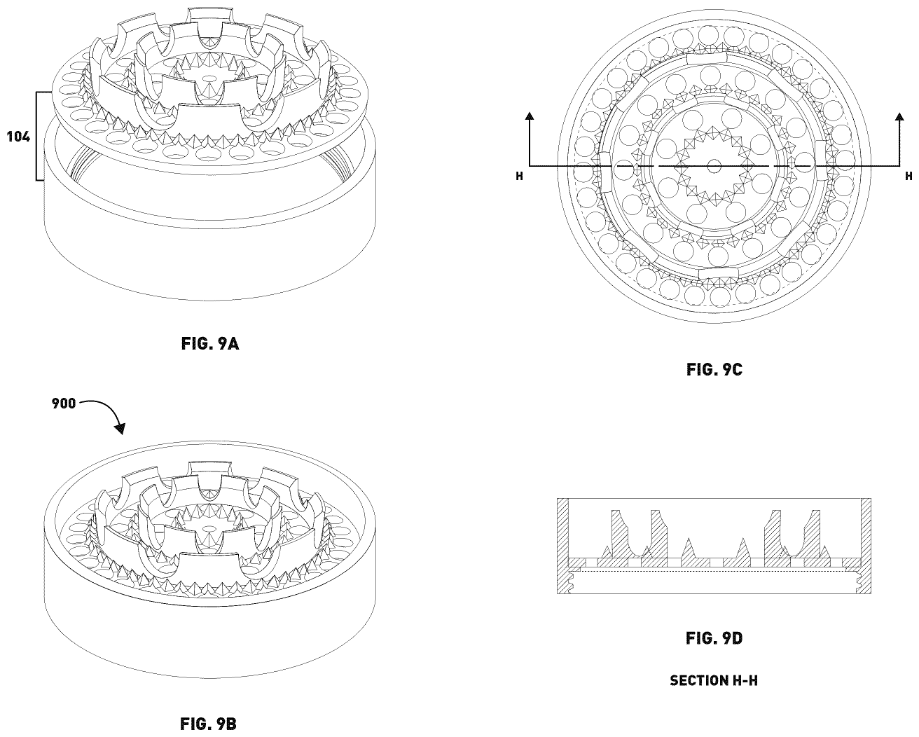

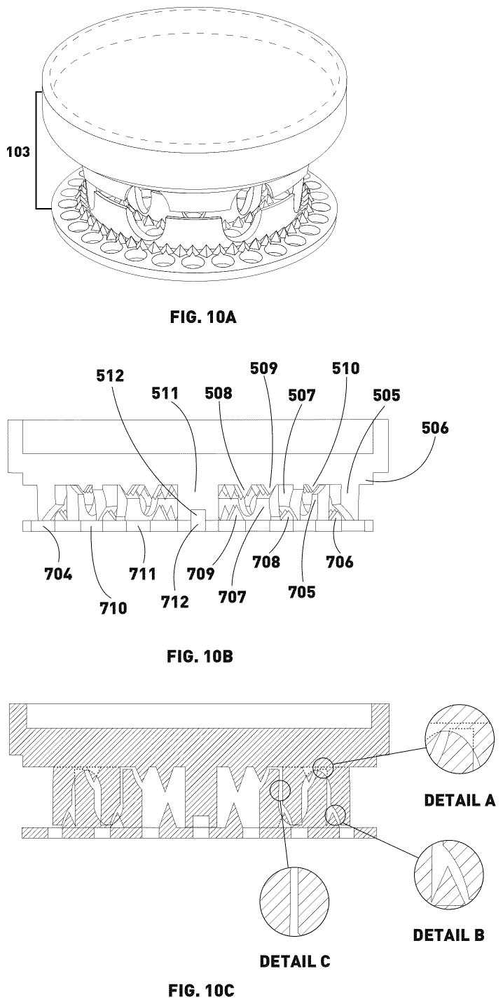

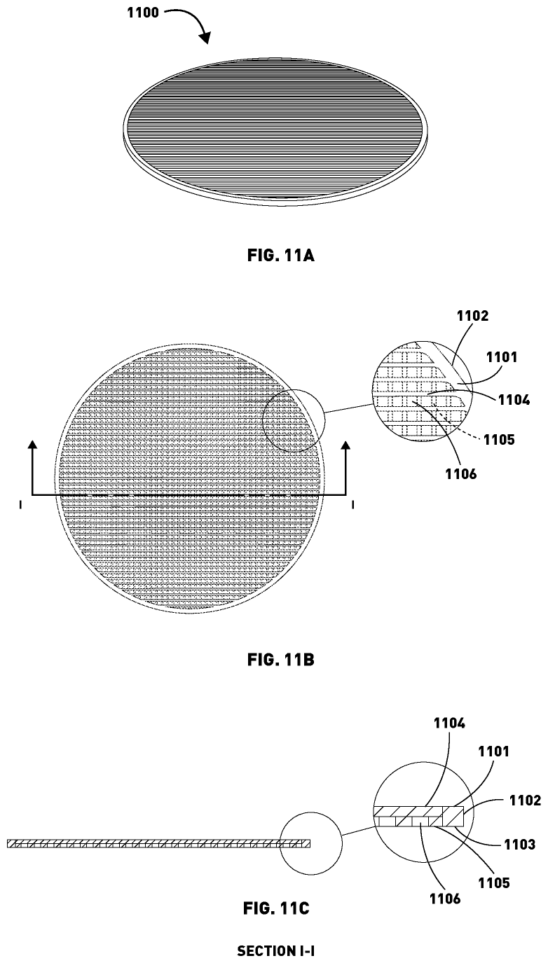

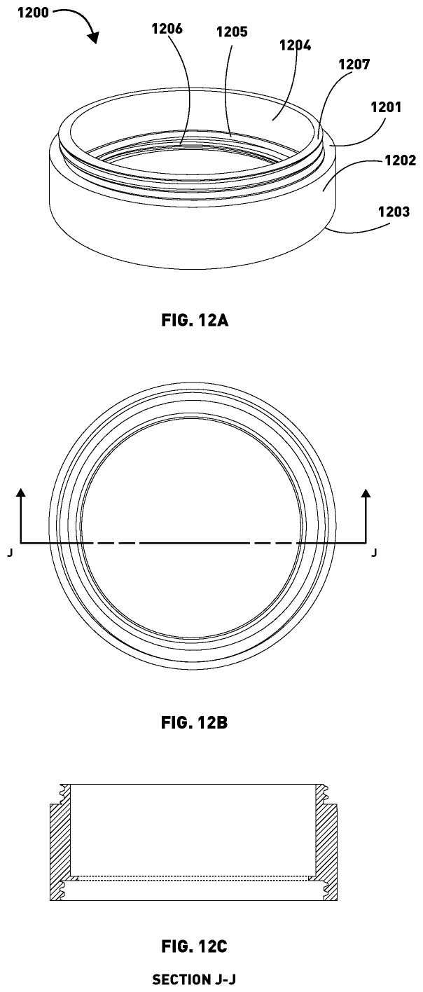

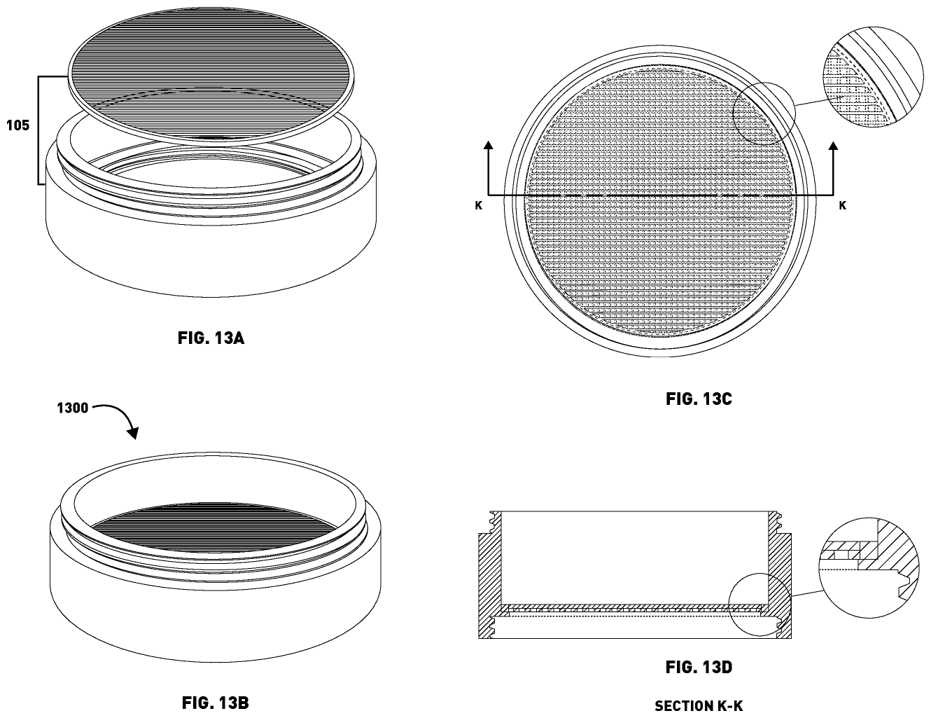

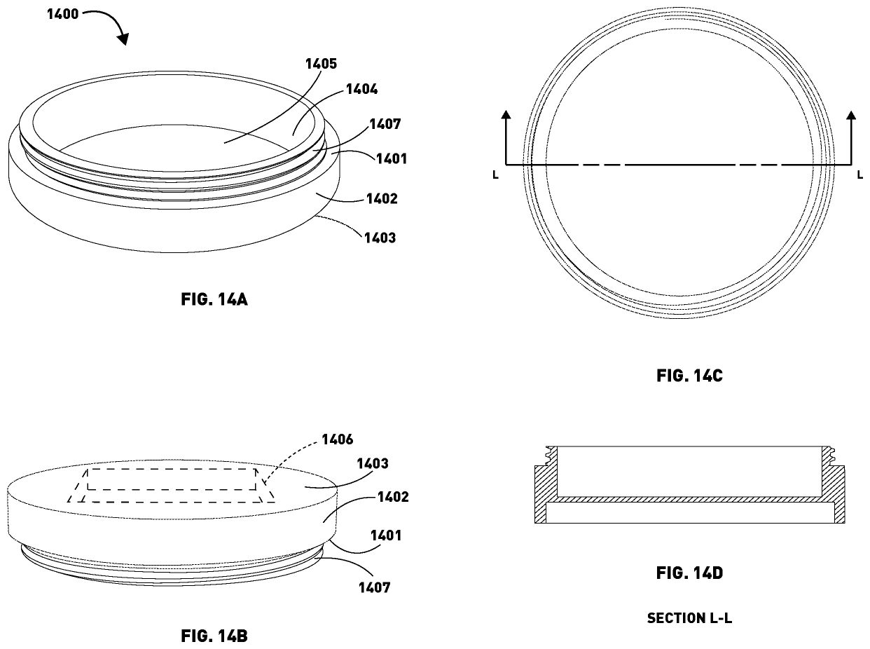

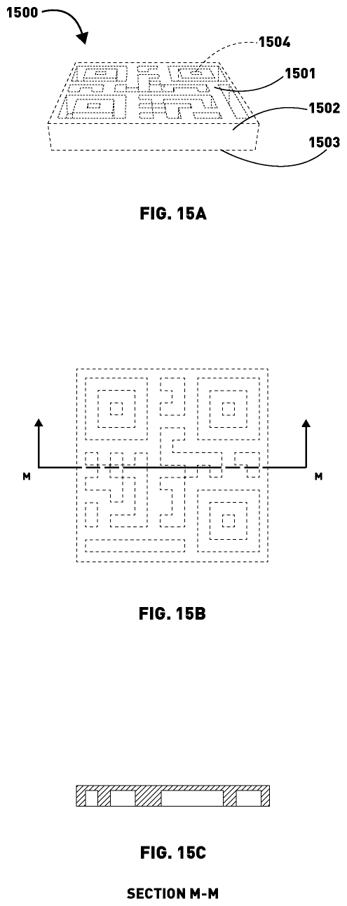

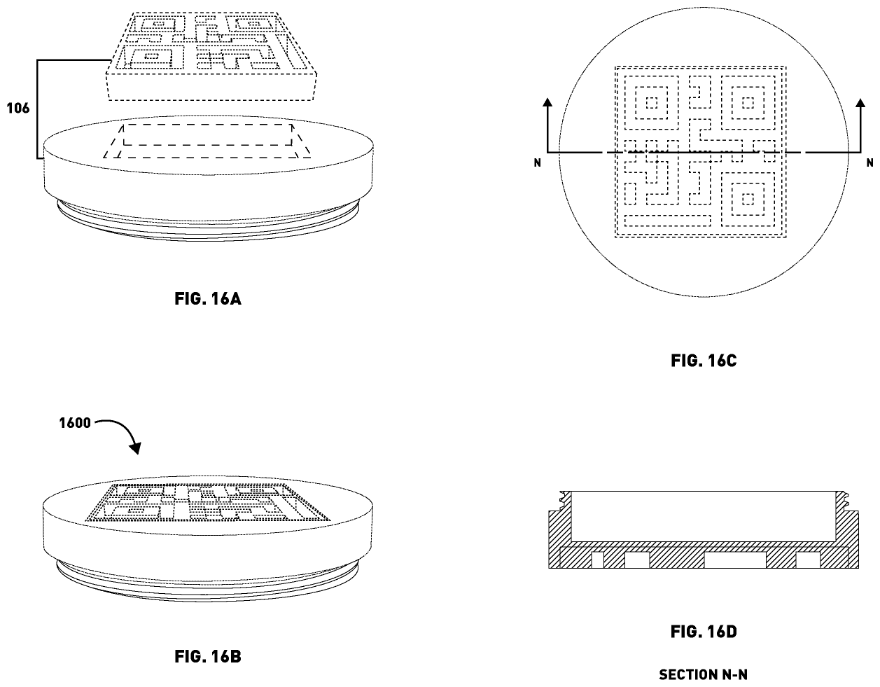

Referring now to the drawings, and in particular to FIG. 1A, an isometric top view of a modular herb grinder assembly 100 is depicted according to an embodiment of the present invention. In this view, herb grinder assembly 100 contains customizable elements rendered in dashed lines to illustrate sample artwork and serve as a visual guide for customization according to an embodiment of the present invention. In another embodiment, herb grinder assembly 100 may be devoid of such customizable elements. Turning to FIG. 1B, an isometric top view of the bottom of herb grinder assembly 100 according to an embodiment of the present invention. In this view, herb grinder assembly 100 contains customizable elements rendered in dashed lines to illustrate sample artwork and serve as a visual guide for customization. In another embodiment, herb grinder assembly 100 may be devoid of such customizable elements. FIG. 1C is an exploded perspective view of herb grinder assembly 100 according to an embodiment of the present invention. In this view, components collectively comprising herb grinder assembly 100 are grouped together via a series of vertical brackets which inform an assembly of their respective constructs and are further explored in subsequent figures. Beginning at the top, an optional combined branding insert assembly 101 is shown connected via a bracket joining a branding frame insert 200 (detailed in FIG. 2A) and a branding plate insert 300 (detailed in FIG. 3A) to inform an assembly of an optional combined branding insert 400 (detailed in FIG. 4B). On the opposite side, a branded upper grinding element assembly 102 is shown connected via a bracket incorporating insert assembly 101 and an upper grinding element 500 (detailed in FIG. 5B) to inform an assembly of a branded upper grinding element 600 (detailed in FIG. 6B) according to an embodiment of the present invention. In another embodiment, upper grinding element 500 may be devoid of such an insert. Beneath insert assembly 101, a dual action grinding mechanism assembly 103 is shown connected via a bracket joining upper grinding element 500 to a lower grinding element 700 (detailed in FIG. 7A) to inform an assembly of a dual action grinding mechanism 1000 (detailed in FIG. 10A) according to an embodiment of the present invention. Beneath branded upper grinding element assembly 102, a grinding chamber base assembly 104 is shown connected via a bracket joining lower grinding element 700 and a grinding chamber shell 800 (detailed in FIG. 8A) to inform an assembly of a grinding chamber base 900 (detailed in FIG. 9B) according to an embodiment of the present invention. Below dual action grinding mechanism assembly 103, a storage chamber base assembly 105 is shown via a bracket connecting a screen insert 1100 (detailed in FIG. 11B) and a storage chamber shell 1200 (detailed in FIG. 12A) to inform an assembly of a storage chamber base 1300 (detailed in FIG. 13B) according to an embodiment of the present invention. Below grinding chamber base assembly 104, a branded trichome chamber assembly 106 is shown via a bracket connecting a trichome chamber 1400 (detailed in FIG. 14A) to an optional QR code insert 1500 (detailed in FIG. 15A) to inform an assembly of a branded trichome chamber 1600 (detailed in FIG. 16B) according to an embodiment of the present invention. In another embodiment, trichome chamber 1400 may be devoid of such an insert. These components may be structured to fit within one another, forming a cohesive and integrated unit when assembled as shown in FIG. 1A and FIG. 1B, according to an embodiment of the present invention. All of the features mentioned in FIG. 1C are according to an embodiment of the present invention.

As previously mentioned in FIG. 1C, FIG. 2A is a perspective top view of a branding frame insert 200 according to an embodiment of the present invention. In this view, branding frame insert 200 contains a top surface 201, extending to the outer edge of an exterior wall 202. Dashed lines indicate a silhouetted void sample artwork 207 to function as a visual example of customization according to an embodiment of the present invention. In this view, sample artwork 207 uses dashed lines to indicate a silhouetted void passing through top surface 201 in a shape corresponding to an extruded sample art 305 of a branding plate insert 300 (detailed in FIG. 3A) which then interlock and form a singular unified surface (as shown in FIG. 4A). FIG. 2B is a perspective top view of the bottom of branding frame insert 200 according to an embodiment of the present invention. In this view, silhouetted void sample art 207 can be seen passing through a bottom surface 203 on its way to the terminus of its journey through top surface 201. Bottom surface 203 extends out to the edge of an interior wall 204, the crest of which forms a bottom rim 205 beset with a plurality of convex nodes 206 which facilitate additional stability between interlocking branding inserts according to an embodiment of the present invention. FIG. 2C is an orthographic top view of the bottom of branding frame insert 200 including a cutting plane line represented by the line labeled Section A-A, according to an embodiment of the present invention. 2D is a sectional profile view of branding frame insert 200, taken along the cutting plane line labeled Section A-A in FIG. 2C according to an embodiment of the present invention.

FIG. 3A is a perspective top view of a branding plate insert 300, as originally referenced in FIG. 1C, according to an embodiment of the present invention. In this view, a top surface 301 serves as a base for an extruded sample artwork 305, indicated here by dashed lines to serve as an illustrative guide for customization according to an embodiment of the present invention. In this view, sample artwork 305 may be extruded to a height that, when paired with sample artwork 207 in a corresponding interlocking branding frame insert 200, forms an optional combined branding insert 400 (detailed in FIG. 4B) which rises through the corresponding void of sample artwork 207 to form a unified surface according to an embodiment of the present invention. An exterior wall 302 is beset with a plurality of concave notches 304 which correspond with a plurality of matching convex nodes 206 and connects to a bottom surface 303 according to an embodiment of the present invention. FIG. 3B is an orthographic top view of branding plate insert 300, including a cutting plane line represented by the line labeled Section B-B, according to an embodiment of the present invention. FIG. 3C is a sectional profile view of branding plate insert 300, taken along the cutting plane line labeled Section B-B in FIG. 3B according to an embodiment of the present invention.

As previously referenced in FIG. 1C, FIG. 4A is a perspective top view of insert assembly 101 according to an embodiment of the present invention. In this view, branding frame insert 200 and branding plate insert 300 interlock to inform an assembly of an optional combined branding insert 400 (detailed in FIG. 4B). FIG. 4B is a perspective top view of an optional combined branding insert 400 according to an embodiment of the present invention. In this view, solid lines indicate the visible bounds of branding frame insert 200 and dashed lines indicate the corresponding sample artwork 305 which interlock to inform an assembly of combined branding insert 400 according to an embodiment of the present invention. FIG. 4C is an orthographic top view of combined branding insert 400 according to an embodiment of the present invention. In this view, as indicated in FIG. 4A, solid lines indicate the visible bounds of branding frame insert 200 and dashed line indicate the visible portion of branding plate insert 300, including a cutting plane line represented by the line labeled Section C-C, according to an embodiment of the present invention. FIG. 4D is a sectional profile view of combined branding insert 400, taken along the cutting plane line labeled Section C-C in FIG. 4B according to an embodiment of the present invention.

FIG. 5A, as originally referenced in FIG. 1C, is a perspective top view of an upper grinding element 500 according to an embodiment of the present invention. In this view, a top surface 501 contains an optional branding insert slot 504 for the inclusion of optional combined branding insert 400 indicated by dashed lines according to an embodiment of the present invention. In another embodiment, upper grinding element 500 may be devoid of such an optional branding insert slot. Top surface 501 extends to the edge of an exterior wall 502 with a retention base 506 further below, upon which an exterior primary teeth ring 505 is set. The combined surfaces of top surface 501 and exterior wall 502 are configured to co-operatively form an ergonomic grip for facilitating manual rotation of upper grinding element 500 thereby functioning as a hand rotor according to an embodiment of the present invention. FIG. 5B is a perspective top view of the underside of grinding element 500 according to an embodiment of the present invention. In this view, a plurality of primary and secondary teeth rings are arranged in concentric, alternating fashion according to an embodiment of the present invention. A bottom surface 503 serves as a base upon which retention base 506 is constructed according to an embodiment of the present invention. Set within retention base 506, an outer primary teeth ring 505 is arranged around the outside of an outer secondary teeth ring 510 according to an embodiment of the present invention. Further inward, an inner primary teeth ring 507 is arranged around the outside of a middle ring of secondary teeth 508 according to an embodiment of the present invention. In the center, an inner secondary teeth ring 509 is arranged around the outside of a central column 511 which contains within it a magnet slot 512 according to an embodiment of the present invention. All of the features mentioned in FIG. 5B are according to an embodiment of the present invention. Furthermore, the present invention includes a plurality of primary and secondary teeth rings, however, the exact number of which is variable and not limited to any specific quantity. This plurality is meant to encompass a range of quantities without being restricted to a predetermined number of said primary and secondary teeth rings. FIG. 5C is an orthographic top view of the bottom of upper grinding element 500, including a cutting plane line represented by the line labeled Section D-D, according to an embodiment of the present invention. FIG. 5D is a sectional profile view of upper grinding element 500, taken along the cutting plane line labeled Section D-D in FIG. 5C, according to an embodiment of the present invention.

As previously referenced in FIG. 1C, FIG. 6A is a perspective top view of branded upper grinding element assembly 102 according to an embodiment of the present invention. In this view, optional combined branding insert 400 is set into upper grinding element 500 comprising branded upper grinding assembly 102. FIG. 6B is a perspective top view of a branded upper grinding element 600 according to an embodiment of the present invention wherein solid lines indicate the visible boundaries of branding frame insert 200 and upper grinding element 500. Dashed lines represent the hidden portions of branding plate insert 300, with the exception of sample artwork 305 which uses dashed lines to serve as a visual guide for customization according to an embodiment of the present invention. FIG. 6C is an orthographic top view of branded upper grinding element 600, wherein solid lines indicate the visible boundaries of branding frame insert 200 and upper grinding element 500. Dashed lines represent the hidden portions of branding plate insert 300, with the exception of sample artwork 305 which uses dashed lines to serve as a visual guide for customization according to an embodiment of the present invention. Additionally included in this view is a cutting plane line labeled Section E-E, according to an embodiment of the present invention. FIG. 6D is a sectional profile view of branded upper grinding element 600 taken along the cutting plane line labeled Section E-E in FIG. 6C, showing the collectively interlocked contents branding frame insert 200, branding plate insert 300, and upper grinding element 500 according to an embodiment of the present invention.

As originally referenced in FIG. 1C, FIG. 7A is a perspective top view of a lower grinding element 700 according to an embodiment of the present invention. In this view, a top surface 701 and a bottom surface 703 are joined by an exterior wall 702. Through these collective surfaces, a plurality of rings of apertures with alternating primary and secondary teeth rings arranged in concentric and alternating fashion according to an embodiment of the present invention. Additionally in this view, set within an outer ring of apertures 704, an outer secondary teeth ring 706 is arranged around the outside of an outer primary teeth ring 705 according to an embodiment of the present invention. Further inward, a middle ring of apertures 710 is arranged around the outside of a middle secondary teeth ring 708 and within that exist an inner primary teeth ring 707 according to an embodiment of the present invention. In the center, an inner ring of apertures 711 surrounds an inner secondary teeth ring 709 which itself surrounds a magnet slot 712 according to an embodiment of the present invention. All of the features of FIG. 7A are according to an embodiment of the present invention. Furthermore, the present invention includes a plurality of rings of apertures as well as primary and secondary teeth rings, however, the exact number of which is variable and not limited to any specific quantity. This plurality is meant to encompass a range of quantities without being restricted to a predetermined number of said primary and secondary teeth rings. FIG. 7B is an orthographic top view of lower grinding element 700 including a cutting plane line represented by the line labeled Section F-F according to an embodiment of the present invention. FIG. 7C is a sectional profile view of lower grinding element 700 taken along the cutting plane line labeled Section F-F in FIG. 7B, according to an embodiment of the present invention.

FIG. 8A is a perspective top view of a grinding chamber shell 800 according to an embodiment of the present invention. In this view, a top surface 801 is joined to a bottom surface 803 by an exterior wall 802. On the opposite side of exterior wall 802, an interior wall 804 leads to a retention ring 805, and finally to an interior female thread 806. All of the features mentioned in FIG. 8A are according to an embodiment of the present invention. FIG. 8B is an orthographic top view of grinding chamber shell 800, including a cutting plane line represented by the line labeled Section G-G, according to an embodiment of the present invention. FIG. 8C is a sectional profile view of grinding chamber shell 800, taken along the cutting plane line labeled Section G-G in FIG. 8B, wherein dashed lines indicate a hollow center according to an embodiment of the present invention.

As previously referenced in FIG. 1C, FIG. 9A is a perspective top view of grinding chamber assembly 104 according to an embodiment of the present invention. In this view, lower grinding element 700 is set into grinding chamber shell 800 comprising grinding chamber assembly 104. FIG. 9B is a perspective top view of a grinding chamber base 900 according to an embodiment of the present invention. FIG. 9C is an orthographic top view of grinding chamber base 900, wherein dashed lines represent hidden retention ring 805 upon which lower grinding element 700 rests, including a cutting plane line represented by the line labeled Section H-H, according to an embodiment of the present invention. FIG. 9D is a sectional profile view of grinding chamber base 900 taken along the cutting plane line labeled Section H-H in FIG. 9C according to an embodiment of the present invention.

FIG. 10A, as originally referenced in FIG. 1C, is a perspective top view of dual action grinding mechanism assembly 103 according to an embodiment of the present invention. In this view, upper grinding element 500 and lower grinding element 700 combine to comprise grinding chamber assembly 104. FIG. 10B is a sectional perspective profile view of upper grinding element 500 and lower grinding element 700 combined to inform an assembly of a dual action grinding mechanism 1000 according to an embodiment of the present invention. In this view, outer primary teeth ring 505 and inner primary teeth ring 507 of upper grinding element 500 slidably engage at the edges with corresponding outer primary teeth ring 705 and inner primary teeth ring 707 of lower grinding element 700 respectively, in an intermeshing fashion, functioning as the first action of dual action grinding mechanism 1000 according to an embodiment of the present invention. Further, outer secondary teeth ring 706 and middle secondary teeth ring 708 engage the upper slope of outer primary teeth ring 505 and inner primary teeth ring 507 in a pulverizing motion according to an embodiment of the present invention. Similarly, outer secondary teeth ring 510 and middle secondary teeth ring 509 engage the upper slope of outer primary teeth ring 705 and inner primary teeth ring 707 in a pulverizing motion according to an embodiment of the present invention. This pulverization interaction between corresponding secondary teeth rings and primary teeth rings functions as the second action of dual action grinding mechanism 1000 according to an embodiment of the present invention. All of the features described in FIG. 10A are according to an embodiment of the present invention. Furthermore, the present invention includes a plurality of primary and secondary teeth rings, however, the exact number of which is variable and not limited to any specific quantity. This plurality is meant to encompass a range of quantities without being restricted to a predetermined number of said primary and secondary teeth rings. FIG. 10C is a composite sectional profile view combining Section D-D of FIG. 5D and Section F-F of FIG. 7C to inform assembly of dual action grinding mechanism 1000, wherein details of engagement between previously mentioned features may be examined further. A call-out circle connecting to a window titled Detail A features a close-up view of a feature of dual action grinding mechanism 1000 wherein an example is shown concerning outer primary teeth ring 705 and retention base 506 come to rest with intentional space between the engagement surfaces to protect them from wear and vertical shock as demonstrated in this view according to an embodiment of the present invention. In the next call-out circle connecting to a window titled Detail B, a close-up view of a feature of dual action grinding mechanism 1000 wherein an example is shown concerning the intermeshing relationship between outer secondary teeth ring 706 and outer primary teeth ring 505 further demonstrating the secondary action referenced in FIG. 10B according to an embodiment of the present invention. In a final call-out circle connecting to a window titled Detail C, a close-up view of a feature of dual action grinding mechanism 1000 wherein an example is shown concerning the intermeshing relationship between inner primary teeth ring 707 and inner primary teeth ring 507 further demonstrating the primary action referenced in FIG. 10A according to an embodiment of the present invention. All of the features of FIG. 10C are according to an embodiment of the present invention.

FIG. 11A is a perspective top view of a screen insert 1100 according to an embodiment of the present invention. FIG. 11B is an orthographic top view of screen insert 1100 upon which a call-out circle is placed and connected to a detail window. In this close-up view, a plurality of horizontal slats 1104 are attached to an adjoining ring top surface 1101 and an exterior wall 1102 according to an embodiment of the present invention. Additionally in this view, a cutting plane line is shown represented by the line labeled Section I-I according to an embodiment of the present invention. FIG. 11C is a sectional profile view of screen insert 1100 taken along the cutting plane line labeled Section I-I in FIG. 11B according to an embodiment of the present invention and features a call-out circle connecting to a detail window. In this close-up view, a plurality of vertical slats 1105 is seen attached laterally to the underside of horizontal slats 1104 and vertically to an adjoining ring bottom surface 1103 according to an embodiment of the present invention. The crossing of horizontal slats 1104 and vertical slats 1105 creates a plurality of voids 1106 which are formed by the resulting spaces and acts as a sieve according to an embodiment of the present invention.

FIG. 12A is a perspective top view of a storage chamber shell 1200 according to an embodiment of the present invention. In this view, an exterior male thread 1207, acting as an attachment mechanism to secure storage chamber shell 1200 to a trichome chamber 1400, is affixed to a top surface 1201 which is joined to a bottom surface 1203 by an exterior wall 1202 according to an embodiment of the present invention. Opposite exterior wall 1202, an interior wall 1204 contains a retention ring 1205, and further below, an interior female thread 1206 according to an embodiment of the present invention. FIG. 12B is an orthographic top view of storage chamber shell 1200 including a cutting plane line represented by the line labeled Section J-J according to an embodiment of the present invention. FIG. 12C is a sectional profile view of storage chamber shell 1200, taken along the cutting plane line labeled Section J-J in FIG. 12B, wherein dashed lines indicate a hollow center according to an embodiment of the present invention.

FIG. 13A, as originally referenced in FIG. 1C, is a perspective top view of storage chamber assembly 105 according to an embodiment of the present invention. In this view, screen insert 1100 is set into storage chamber shell 1200 comprising storage chamber assembly 105. FIG. 13B is a perspective top view of a storage chamber base 1300 according to an embodiment of the present invention. FIG. 13C is an orthographic top view of storage chamber base 1300, wherein dashed lines represent hidden retention ring 1205 upon which screen insert 1100 rests, including a cutting plane line represented by the line labeled Section K-K according to an embodiment of the present invention. A detail window with a close-up view has been included for greater comprehension. FIG. 13D is a sectional profile view of storage chamber base 1300, taken along the cutting plane line labeled Section K-K in FIG. 13C according to an embodiment of the present invention. A detail window with a close-up view has been included for greater comprehension.

FIG. 14A is a perspective top view of a trichome chamber 1400 according to an embodiment of the present invention. In this view, an exterior male thread 1407 acting as an attachment mechanism to secure trichome chamber 1400 to storage chamber shell 1200 is affixed to a top surface 1401 which is joined to a bottom surface 1403 by an exterior wall 1402 according to an embodiment of the present invention. On the opposite side of exterior male thread 1407, an interior wall 1404 ends at an interior floor 1405 according to an embodiment of the present invention. FIG. 14B is a perspective view of the top of the underside of trichome chamber 1400 according to an embodiment of the present invention. In this view, bottom surface 1403 contains an optional QR code insert slot 1406 is indicated by a dashed line according to an embodiment of the present invention. In another embodiment, trichome chamber 1400 may be devoid of such an optional QR code insert slot. FIG. 14C is an orthographic top view of trichome chamber 1400, including a cutting plane line represented by the line labeled Section L-L, according to an embodiment of the present invention. FIG. 14D is a sectional profile view of trichome chamber 1400, taken along the cutting plane line labeled Section L-L in FIG. 14C according to an embodiment of the present invention.

FIG. 15A is a perspective top view of an optional QR code insert 1500, wherein dashed lines act as a visual example of customization according to an embodiment of the present invention. In this view, an exterior wall 1502 connects a bottom surface 1503 to a top surface 1501 according to an embodiment of the present invention. Set into top surface 1501, a sample QR code 1504 integrates a three-dimensional method of rendering fiducial markers by extruding positive shapes usually indicated by white coloring and voiding negative shapes usually indicated by black coloring on traditional flat QR codes, enabling optional QR code insert 1500 to function identically to a two-dimensional QR code according to an embodiment of the present invention. FIG. 15B is an orthographic top view of QR code insert 1500, wherein dashed lines function as a visual example of customization, and which includes a cutting plane line represented by the line labeled Section M-M according to an embodiment of the present invention. FIG. 15C is a sectional profile view of QR code insert 1500, taken along the cutting plane line labeled Section M-M in FIG. 15B according to an embodiment of the present invention.

FIG. 16A, as originally referenced in FIG. 1C, is a perspective top view of branded trichome chamber assembly 106 according to an embodiment of the present invention. In this view, optional QR code insert 1500 is set into trichome chamber 1400 comprising branded trichome chamber assembly 106. FIG. 16B is a perspective view of the bottom of a branded trichome chamber 1600. In this view, the outermost dashed line represents optional QR code insert slot 1406 and the remaining dashed lines indicate a visual example of customization according to an embodiment of the present invention. FIG. 16C is an orthographic top view of the bottom of branded trichome chamber 1600, wherein the outermost dashed line represents optional QR code insert slot 1406 and the remaining dashed lines indicate a visual example of customization according to an embodiment of the present invention. Included in this view is a cutting plane line represented by the line labeled Section N-N according to an embodiment of the present invention. FIG. 16D is a sectional profile view of branded trichome chamber 1600, taken along the cutting plane line labeled Section N-N in FIG. 16C according to an embodiment of the present invention.

It will be apparent to one with skill in the art that the novel aspects of the invention may be provided using some, or all, of the mentioned features and components without departing from the spirit and scope of the present invention. It will also be apparent to the skilled artisan that the embodiments described above are specific examples of a broader invention which may have greater scope than any of the singular descriptions taught. There may be many alterations made in the descriptions without departing from the spirit and scope of the present invention.

What is claimed is:

1. A device for herb grinding comprising;
a modular cylindrical assembly including;
an upper grinding element comprising;
a top surface;
an exterior wall;
wherein the top surface and exterior wall are configured to
co-operatively form an ergonomic grip for facilitating manual rotation of the upper grinding element, thereby functioning as a hand rotor;
and optionally, a slot configured to receive a combined branding insert;
a retention base;
a plurality of primary teeth rings;
a plurality of secondary teeth rings;
wherein said primary teeth rings and said secondary teeth rings are arranged in alternating fashion; and
a central column;
wherein said central column contains a slot configured to accommodate a magnet for attachment to a corresponding magnet in a slot within a lower grinding element as an attachment mechanism;
a grinding chamber base comprising;
a lower grinding element including;
a plurality of primary teeth rings;
wherein said primary teeth rings are designed to correspond with primary teeth of said upper grinding element;
a plurality of secondary teeth rings;
wherein said secondary teeth rings and said primary teeth rings are arranged in alternating fashion;
a top surface;
wherein said primary teeth rings and said secondary teeth rings are extruded from said top surface;
an exterior wall;
a bottom surface;
a plurality of apertures;
wherein said apertures pass through said top and bottom surfaces, align with the edges of corresponding primary teeth of said upper grinding element; and
which contains a central slot configured to accommodate a magnet for attachment to a corresponding magnet in said upper grinding element as an attachment mechanism;
a grinding chamber shell further including;
an exterior wall;
an interior wall;
a retention ring;
wherein said retention ring is configured to secure said lower grinding element within said grinding chamber base; and
an internal female thread;
wherein said internal female thread acts as an attachment mechanism for securing a grinding chamber to a storage chamber;
a storage chamber base comprising;
a screen insert further comprising;
an external retention ring;
a plurality of horizontal slats;
wherein said horizontal slats are attached to the top of said external retention ring;
a plurality of vertical slats;
wherein said vertical slats are attached to the bottom of said external retention ring; and
a plurality of voids;
wherein said voids are formed by the perpendicular orientation of said vertical and said horizontal slats;
a storage chamber shell containing;
an external male thread;
wherein said external male thread acts as an attachment mechanism for securing a storage chamber to a trichome chamber;
a top surface;
wherein said external male thread is extruded from said top surface;
an exterior wall;
an interior wall;
a retention ring;
wherein said retention ring is designed to secure said screen insert within said storage chamber base; and
an internal female thread;
wherein said internal female thread acts as an attachment mechanism for securing a storage chamber to a trichome chamber;
a trichome chamber comprising;
an external male thread;
wherein said external male thread acts as an attachment mechanism for securing said storage chamber to said trichome chamber;
a top surface;
wherein said external male thread is extruded from said top surface;
an interior wall;
an interior floor;
wherein said interior wall and interior floor collectively comprise a trichome collection area;
an exterior wall; and
a bottom surface;
wherein said bottom surface optionally contains a slot configured to receive a QR code insert.

2. A device for herb grinding comprising;
a dual action grinding mechanism further comprising;
an upper grinding element containing;
a plurality of primary teeth rings;
wherein said primary teeth rings are designed with concave and curvilinear geometry which slidably engage with outer surfaces of corresponding primary teeth of a lower grinding element;
a plurality of secondary teeth rings;
wherein said secondary teeth rings are designed with convex and rectilinear geometry which further engage with inner surfaces of corresponding primary teeth rings of a lower grinding element;
a lower grinding element containing;
a plurality of primary teeth rings;
wherein said primary teeth rings are designed with concave and curvilinear geometry which slidably engage with outer surfaces of corresponding primary teeth of said upper grinding element;
a plurality of secondary teeth rings;
wherein said secondary teeth rings are designed with convex and rectilinear geometry which further engage with inner surfaces of corresponding primary teeth rings of said upper grinding element;

3. A method for customizing the device of claim 1 comprising;
a branding frame insert containing;
a top surface;
a bottom surface;
a silhouetted void artwork;
wherein said silhouetted void passes through said top surface and said bottom surface in a shape to receive an extruded artwork from a corresponding branding frame plate;
an exterior wall;
an interior wall; and
a bottom rim;
wherein said bottom rim is formed by the space between said exterior wall and said interior wall; and
contains a plurality of convex nodes;
a branding plate insert comprising;
a top surface;
an extruded artwork;
wherein said extruded artwork is raised from said top surface and structured to rise through the silhouetted void of said branding frame insert to form a unified surface;
a bottom surface; and
an exterior wall;
wherein said exterior wall contains a plurality of concave notches which correspond with convex notches in said branding frame insert;
a QR code insert comprising;
a top surface;
wherein said top surface customization includes a user-selected array of specific positive and negative shapes to represent specific data; and
scanning the QR code insert with a scanning device to interpret the data represented by the combination of positive shapes and negative shapes;
an exterior wall; and
a bottom surface.
